(19) United States
(12) Patent Application Publication
(10) Pub. No.: US 2006/0144528 A1
(43) Pub. Date: Jul. 6, 2006

(54) Folding and spreading system for half spread folding door

(76) Inventor: Wan Young Lee, (US)

Correspondence Address: SHERIDAN ROSS PC, 1560 BROADWAY, SUITE 1200, DENVER, CO, 80202, US

(21) Appl. No.: 10/562,180

(22) PCT Filed: Apr. 7, 2005
(86) PCT No.: PCT/KR05/00999

§ 371 Date: Dec. 22, 2005

(30) Foreign Application Priority Data
Apr. 8, 2004 (KR) 10-2004-0024164

(51) Int. Cl. E06B 3/48

(52) U.S. Cl. 160/183

(57) ABSTRACT

A folding and spreading system for a half spread folding comprises an upper and a lower guider for making the folding door move in a close or open direction; a first wire guider provided at the depth portion of each door leaf in a predetermined distance from a neighboring first wire guider, and a second wire guider installed coaxially to the first wire guider; a folding motor and a spreading motor provided at both end frames of the folding door, respectively, and having a reel at each rotational shaft of each motor; and a winding wire and a releasing wire extended diagonally through each of the wire guiders of each door leaf, respective end of the wires connected to the wire guider and to the reel of the motor, respectively, in order to fold and spread the adjacent two door leaves around the hinge.

### TECHNICAL FIELD

The present invention relates to a folding and spreading system for a half spread folding door for opening/closing the entrance of all sorts of structures. More particularly, the invention relates to a folding and spreading system whereby both vertical ends of each door leaf that composes the spread folding door is successively connected with a hinge means, the door has a zigzag form when it is fully opened, and the moment generated around the hinge means according to the close/open pulling force is simultaneously applied to each door leaf so that it can obtain the easy open/close operation of a folding door.

### BACKGROUND ART

Generally, since a large structure such as a depot of a grand scale logistic system, a warehouse of various industrial supplies, or an air shed must keep large articles, its entrance should be very large and its door has an extra large size which varies from several meters to a dozen meters in its width and height. Therefore, the door should have from several hundred kilograms to several tons in weight, and its smooth opening/closing is a necessity and its high rigidity is required to resist an external force like the wind.

Such a door can be employed as a sliding door for being thrust in a right/left direction, as a folding door, in which the folding door leaves are folded when the door is opened and the folding door leaves are spread when the door is closed, as a swing door for being open/closed centering around a shaft installed at one end of the door, and as a shutter that is rolled up when open and for being unfolded when closed.

However, it is very difficult for a swing door to adapt to an entrance of a large structure having very large size and weight owing to its structural characteristic.

Further, a sliding door, and a folding door could generally be applied to an entrance of a large structure. Sometimes, a shutter can be employed.

For instance, a sliding door for an air shed is described in Korean Patent Laid-Open No. 2002-0028596 and Korean Utility Model Registration No. 20-0227782.

Furthermore, European Patent EP 1088959 A1 describes a folding door in which multiple door leaves are hinge connected serially to be folded or spread in a form of a zigzag. More, Korean Utility Model Registration No. 20-0318037 describes a folding shutter in which multiple slates are hinge connected serially to be rolled up and unfolded in a form of a zigzag.

However, in the conventional doors, each face of a door leaf is positioned on the same plane or the same direction and the rigidity of a door depends entirely on the material and thickness of the door. Thus, the door must be manufactured with a large thickness to ensure rigidity against an external force like a strong wind and it leads to a problem in which the door becomes very heavy in weight and so folding and stretching operation of the door is not easy.

Particularly, in the case of a folding door, since each door member is placed on the same plane when a door is fully spread, relative high force is required to fold the fully spread door and it is hard to make a folding operation smooth.

To solve the problems mentioned above, the applicant has suggested Korean Patent No. 2003-0051934 entitled as “Half spread folding door”, in which multiple door leaves hinge connected to each other have a spread angle confining means, by which the door has a form of zigzag even when it is fully closed. The abstract configuration is shown in FIGS. 1 to 4.

Multiple door leaves 1 are connected with a hinge means 2 at each joint, and a stop elements 3a, 3b are provided at each hinge means 2 to restrict a spread angle θ of the door. When the door is fully closed, the rotation angle of each door leaf is restricted so that the door has a form of a zigzag. A thinner thickness door than a conventional flat folding door can be configured using the same property material, which attains the very lighter but highly rigid door. The door can be easily open/closed with little force and also the door can be smoothly folded during its opening operation.

Furthermore, since a sliding door and a folding door have a heavy weight, a rotation force of a motor must generally operate them. As previously described in Korean Patent laid-Open No. 2002-0028596 and Koran Utility Model Registration No. 20-0227782, a pin or a roller is installed at a guide channel of a door frame provided at upper ends of each door leaf. At each lower end of the door leaf is installed a driving roller which runs on a guide rail. The last driving roller is connected with a motor that operates the door.

However, the conventional opening and closing system of a sliding door or a folding door is constructed such that the force of a motor is directly delivered only to one door leaf provided at a free end of a door, but indirectly to the remaining door leaves. The multiple remaining door leaves are being operated according to the entire movement of the free end door leaf. It has a problem in that it is hard to make a folding and stretching operation smooth and it requires a motor of a high capacity.

### DISCLOSURE OF INVENTION

Technical Problem

According to the present invention, to order to resolve these problems, an object of the present invention is to provide a folding and spreading system for a half spread folding door, whereby the moment generated by the pulling of the wire is simultaneously applied to each door leaf composing the folding door, by which the folding door can be closed/open easily and rapidly.

It is a further object of the present invention to provide a folding and spreading system for a half spread folding door, whereby the easy operation can be achieved even by the very smaller capacity motors, and the smooth close/open operation can be attained.

Technical Solution

In order to accomplish the object of the present invention, a folding and spreading system for a half spread folding door is used as an entrance of a large structure such as a depot or an air shed, each door leaf being successively connected with a hinge means, and the door having a zigzag form in its fully open state: the folding and spreading system comprises an upper and a lower guiding means for making the folding door move in a close or open direction; a first wire guider provided at the depth portion of each door leaf in a predetermined distance from a neighboring first wire guider, and a second wire guider installed coaxially to the first wire guider; a folding motor and a spreading motor provided at a free end frame and a fixed end frame of the folding door, respectively, and having a reel at each rotational shaft of each motor; and a winding wire and a releasing wire extended diagonally through each of the first wire guider and the second wire guider of each door leaf, each end of the winding wire fixedly connected to the first wire guider of the free end leaf and to the winding reel of the folding motor, respectively, each end of the releasing wire fixedly connected to the second wire guider of the fixed end leaf and to the releasing reel of the spreading motor, respectively, in order to fold and spread the adjacent two door leaves around the hinge means.

According to the present invention, it is preferable that a couple of wire guiders are installed at the top plan of each door leaf, or inside each door leaf.

It is preferable that a first wire guider is installed at the top plan of each door leaf, and a second wire guider is installed inside each door leaf.

It is preferable that a couple of wire guiders are comprised with a pulley rotationally provided at each door leaf.

It is preferable that a motor running in the forward or reverse direction is further installed at the free end leaf of the folding door, the motor is connected to the wheel through a power delivery means, and the motor operates in synchronous with the folding motor and the spreading motor.

Advantageous Effects

Accordingly, the moment generated by the pulling of the wire is simultaneously applied to each door leaf composing the folding door, by which the folding door can be closed/open easily and rapidly.

Furthermore, the easy operation can be achieved even by the very smaller capacity motors, and convenience of usage can be increased.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 are a front view and a top plan view showing the spread state of a half spread folding employing the present invention, respectively;

FIGS. 3 and 4 are top plan views illustrating a folding state and a spread state of a spread confining means of FIGS. 1 and 2;

FIG. 5 is a front view of a half spread folding door having a folding and spreading system according to a first embodiment of the present invention;

FIG. 6 is a top plan view of FIG. 5:

FIG. 7 is a perspective view along arrow V of FIG. 6;

FIG. 8 is a sectional view along line VI-VI of FIG. 5;

FIG. 9 is a sectional view along line VII-VII of FIG. 5;

FIG. 10 is a top plan view along arrow VIII of FIG. 9;

FIGS. 11 and 12 are front views showing a tension maintainable means of FIG. 5;

FIGS. 13 and 14 are conceptual views illustrating operation of a folding and spreading system for half spread folding door according to the present invention;

FIGS. 15 and 16 are top plan views illustrating a folding state of a folding and spreading system according to the present invention;

FIGS. 17 and 18 are top plan views illustrating a spreading state of a folding and spreading system according to the present invention;

FIG. 19 is a front view of a half spread folding door having a folding and spreading system according to a second embodiment of the present invention;

FIG. 20 is a top plan view of FIG. 19:

FIG. 21 is a sectional view showing a driving member of a leading door of FIG. 19;

FIG. 22 is a sectional view along line XVI-XVI of FIG. 21;

FIG. 23 is a sectional view along line XVII-XVII of FIG. 19;

FIGS. 24 and 25 are top plan views illustrating a folding and spreading state of a folding and spreading system according to a second embodiment;

FIGS. 26 to 28 are a front view and sectional top plan view illustrating wire installation of a folding and spreading system, respectively;

FIGS. 29 and 30 are a front view and a top plan sectional view of a folding and spreading system according to a third embodiment, respectively;

FIG. 31 is an enlarged sectional view of C portion of FIG. 30;

FIG. 32 is a sectional view showing a connection between a door leaf and a door frame according to a third embodiment;

FIGS. 33 and 34 are sectional views showing operation of a folding and spreading system according to a third embodiment; and

FIG. 35 is a front view of a shutter adapting another configuration to a third embodiment.

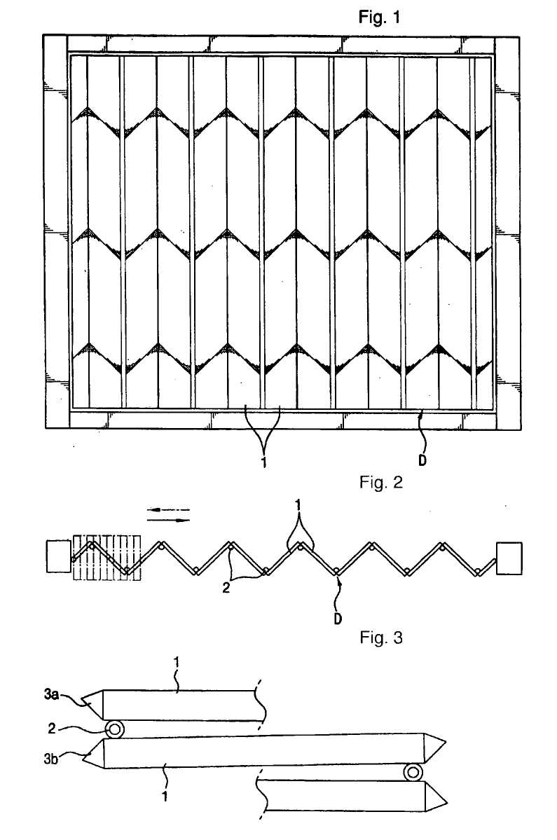

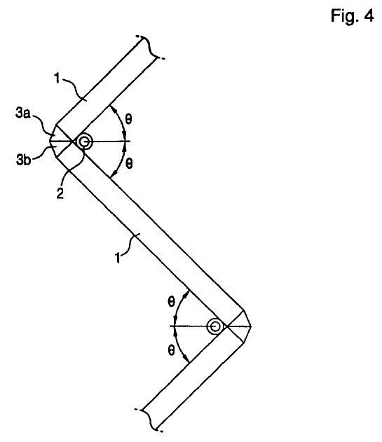

### BEST MODE FOR CARRYING OUT THE INVENTION

This invention will be described in further detail by way of exemplary embodiments with reference to the accompanying drawings.

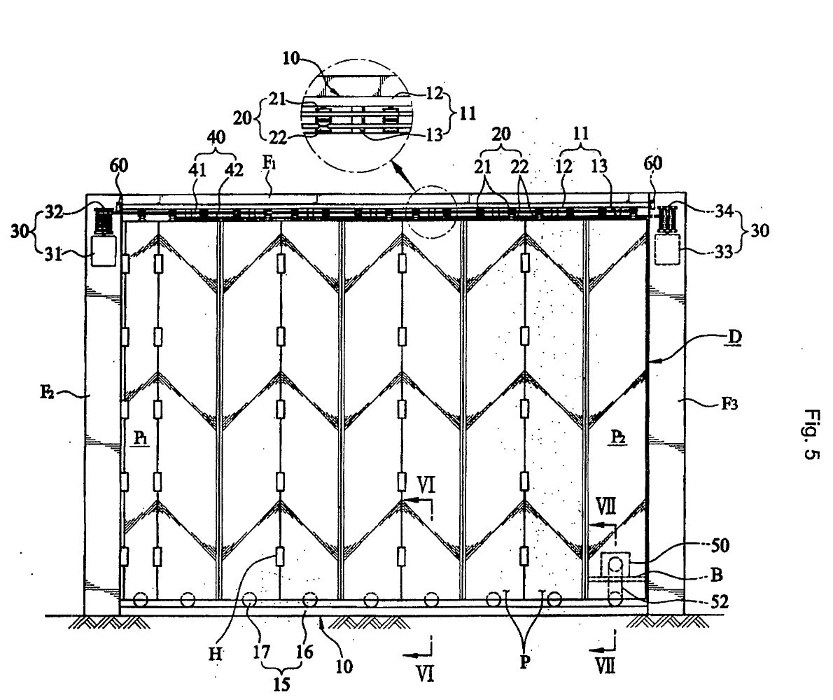

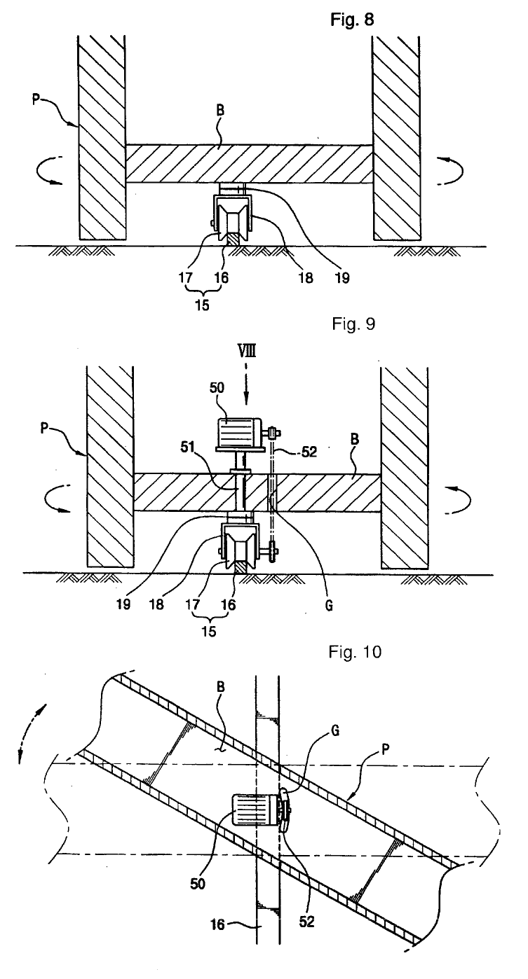

As shown in FIGS. 5 to 10, the folding and spreading system for a half spread folding door is fundamentally comprised of a guiding means 10 for making a folding door D move in a horizontal direction, a pair of wire guiders 20 provided at each door leaf P in a width direction, a motor 30 provided at a door frame F in order to open/close the folding door D, and a pair of wires 40 running continuously along a pair of wire guiders 20, being operated by the motor 30, and making a pair of door leaves P folded/unfolded around a hinge of the door leaf P.

In the folding door D, a hinge means H connects successively each door leaf P with adjacent door leaf P along its width direction, and allows each door leaf P to be rotated around the hinge means H correlatively. A stopper S is provided at each hinge means H in order to limit a rotation angle of each door leaf P. The folding door D has a form of a zigzag (at a plane direction) when it is fully open.

The guiding means 10 comprises an upper guider 11 for conducting a movement of an upper end of the folding door D with a support of an upper door frame F1, and a lower guider 15 for conducting a movement of a lower end of the folding door D with a support of a lower door frame or of a ground.

The upper guider 11 is comprised of a guide channel 12 provided below the upper door frame F1 and extended along a movement of the folding door D, and multiple support pins 13 uprightly extruded from the top end of each door leaf P and slidingly inserted into the guide channel 12. Each support pin 13 is located at a middle depth of the door leaf P. Preferably, the guiding means 10 can be further comprised of a roller 14 rotationally coupled with the support pin 13 and sliding in the guide channel 12, enabling the folding door D to move smoothly with stability.

The lower guider 15 is comprised of a rail 16 provided at the lower door frame or a ground with being faced to the guide channel 12 of the upper guider 11, and multiple wheels 17 provided rotationally at the lower end of the each door leaf P and running on the rail 16. That is, the wheel 17 is connected with the door leaf P through a fork 18 and a thrust bearing 19. Each door leaf P can rotate around the hinge means H even though the wheel 17 makes a linear movement with the door leaf P.

The wire guider 20 can be configured as a single element, but to get more efficient operation, the wire guider 20 preferably is comprised of a first wire guider 21, and a second wire guider 22 which are installed coaxially. As shown FIG. 7, a couple of wire guiders 20 are provided at the depth portion of each door leaf P in a certain distance. The configuration of a couple of wire guiders 20 leads no-interference between a winding wire 41 and a releasing wire 42 running on each wire guider 21, 22 in an opposite direction.

Since a couple of wire guiders 21, 22 can merely guide a movement of the wires 41, 42, a pin can be employed instead of the wire guiders 21, 22. Preferably, a pulley is acceptable for the wires 41, 42 to run continually and smoothly along a zigzag path with little resistance.

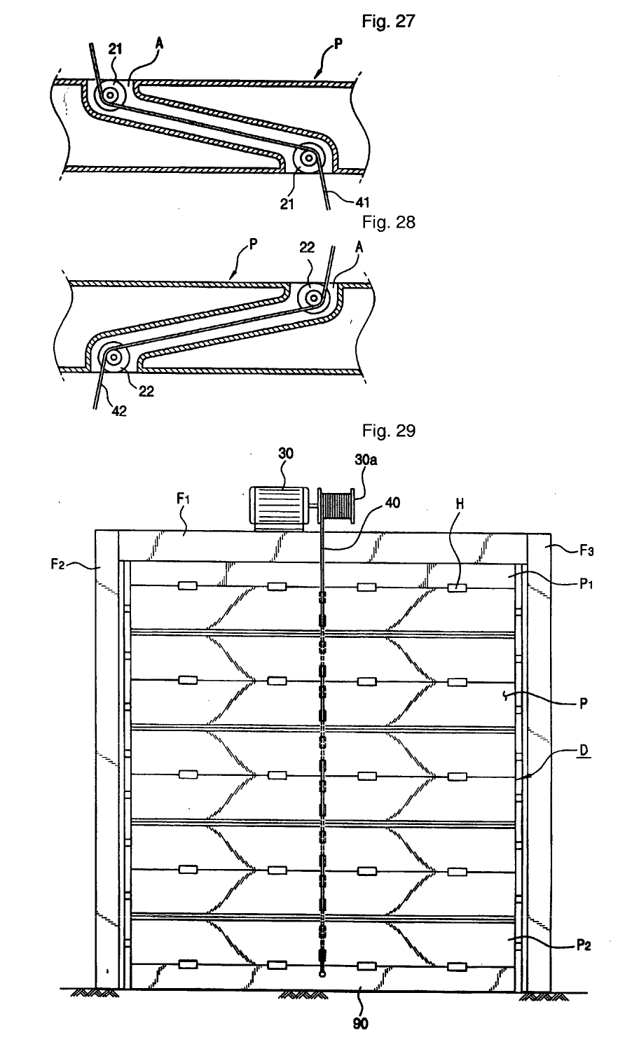

Furthermore, a couple of wire guiders 21, 22 can be installed at the top plan of each door leaf P (FIG. 7) as described earlier. But, as shown in FIGS. 26 to 28, the wire guiders can be provided inside each door leaf P, otherwise, it is not illustrated in drawings, but it is sure that each of wire guider 21, 22 is installed at an upper end and a lower end of each door leaf P, respectively.

In case the wire guiders 21, 22 are installed inside the door leaf P, a guide channel A is configured through a front surface and a back surface of each door leaf P at a corresponding place to each wire guider 21, 22.

The motor 30 is comprised of a folding motor 31 and a spreading motor 33. The folding motor 31 is provided at a fixed end frame F2 of the folding door D in order to be operated only in an opening mode of the folding door D. The spreading motor 33 is provided at a free end frame F3 of the folding door D in order to be operated only in a closing mode of the folding door D. Furthermore, a winding reel 32 and a releasing reel 34 are integrally, respectively, mounted on each rotation shaft of motor 31, 33, in order to wind or release each wire 41, 42.

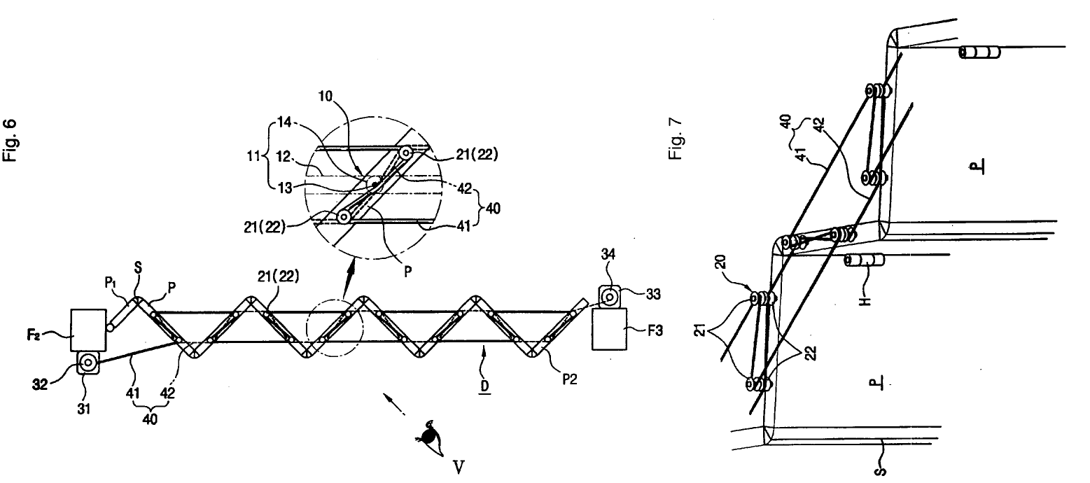

The wire 40 comprises the winding wire 41 and the releasing wire 42, as shown in FIG. 6. One end of the winding wire 41 is fixedly connected to the first wire guider 21 of a free end leaf P2 of the folding door D, and another end of the winding wire 41 is fixedly connected to the winding reel 32 of the folding motor 31. In contrast, one end of the releasing wire 42 is fixedly connected to the second wire guider 22 of a fixed end leaf P1 of the folding door D, and another end of the releasing wire 42 is fixedly connected to the releasing reel 34 of the spreading motor 33.

The winding wire 41 is extended diagonally through each first wire guider 21 of the door leaf P in a zigzag pattern such that the adjacent two door leaves are folded around the hinge means H when the folding motor 31 operates. The releasing wire 42 is extended diagonally through each second wire guider 22 of the door leaf P in a zigzag pattern such that the adjacent two door leaves are spread out around the hinge means H when the spreading motor 33 operates. The extension of the releasing wire 42 has a crisscross path to the extension of the winding wire 41, but opposing each other.

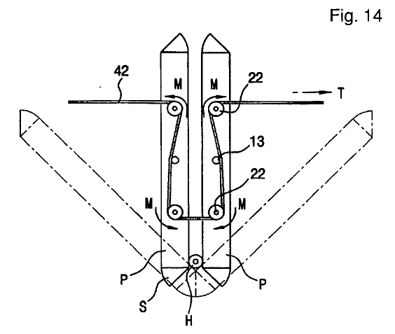

In other words, having a close look to only two adjacent door leaves P as shown FIG. 13, the winding wire 41 runs on the outward path of the first wire guider 21 provided at the free end of each door leaf P and next runs on the inward path of the first wire guider 21 provided at the fixed end of each door leaf P. Thus, two door leaves P are folded as the folding motor 31 operates. In FIG. 14, the releasing wire 42 runs on the inward path of the second wire guider 22 provided at the free end of each door leaf P and next runs on the outward path of the second wire guider 22 provided at the fixed end of each door leaf P. Thus, two door leaves P are spread as the spreading motor 33 operates.

Finally, as shown in FIGS. 6 and 7, the winding wire 41 and the releasing wire 42 run on each wire guider 21, 22 such that each wire crosses.

The above describing configuration has no trouble to operate the folding door D, but it is preferable that a motor 50 running the wheel 17 in the forward or reverse direction can be installed at the free end leaf P2 of the folding door D to get smooth operation.

The motor 50, as shown FIGS. 9 and 10, is housed in the free end door leaf P2, and can make a rotation relative to the door leaf P2 when the door leaf P2 makes a linear and rotational movement. Preferably, the motor 50 can be integrally coupled with a rotatable shaft 51, which penetrates a beam B of the door leaf P2. Furthermore, the motor 50 is connected to the wheel 17 through a chain 52 in order to drive the wheel 17.

To give a path to the chain 52, a chain hole G can be formed at the beam B of the free end leaf P2. The chain hole G is configured as an arch having a curvature being equivalent to a rotation curvature of the door leaf P2, which prevents the rotation of door leaf P2 from being interrupted.

The motor 50 operates in synchronous with the folding motor 31 and the spreading motor 33. The motor 50 synchronizes in a forward direction with the folding motor 31 when the folding door D is open, and synchronizes in a reverse direction with the spreading motor 33 when the folding door D is closed.

A tension maintainable means 60 is provided at a wire 41, 42 path arranged between the fixed end frame F2 and the free end frame F3, which gives a tension to the winding wire 41 and the releasing wire 42.

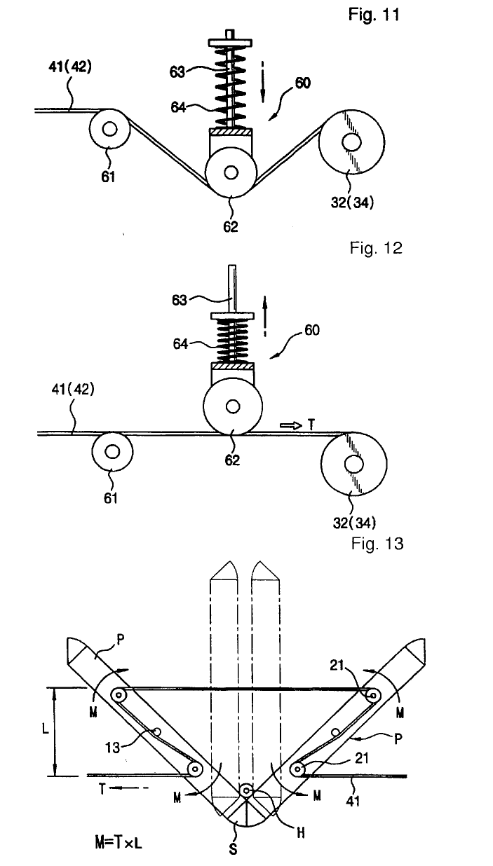

The tension maintainable means 60 can be made with any form, but in this embodiment, as shown in FIGS. 11 and 12, the means 60 is comprised of a support roller 61 and a tension roller 62. The support roller 61 is provided at a wire 41, 42 running path near the folding motor 31 and the spreading motor 33. The tension roller 62 is provided between the motor 31, 33 and the support roller 61, which gives a tension to the wire 41, 42.

Furthermore, the tension roller 62 is mounted at an end of a support rod 63, which slidingly supports each wire 41, 42 in a perpendicular direction to the wire 41, 42. A spring 64 pushes each wire 41, 42 toward the support roller 61, by which the wire 41, 42 can always maintain a proper tension. The value of elasticity of the spring 64 should be established lower than that of the tension of the wire 41, 42.

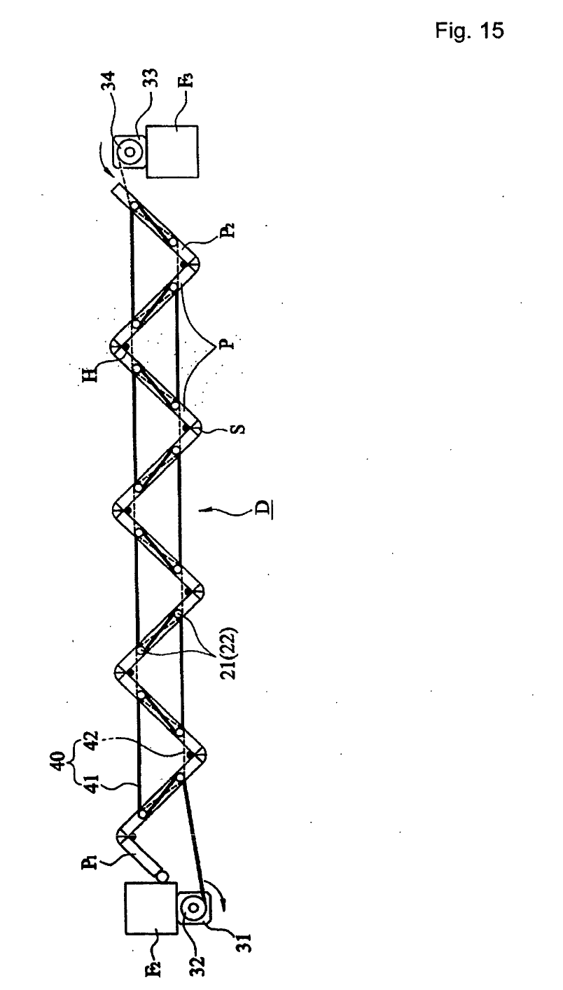

The operation of the folding and spreading system for a half spread folding door will be described herein below with reference to FIGS. 15 to 18.

FIG. 15 illustrates the closed state in that the folding door D is spread in a zigzag fashion to close an entrance of a structure (not shown). The winding wire 41 is released from the reel 32 of the folding motor 31, and the releasing wire 42 is wound on the reel 34 of the spreading motor 33. The tension roller 62 as shown FIG. 11, which can maintain a proper tension, pushes each wire 41, 42.

As an open switch (not shown) turns on, power is given to the folding motor 31. The shaft of the folding motor 31 turns in a winding direction, and also turns the reel 32 provided on the folding motor 31.

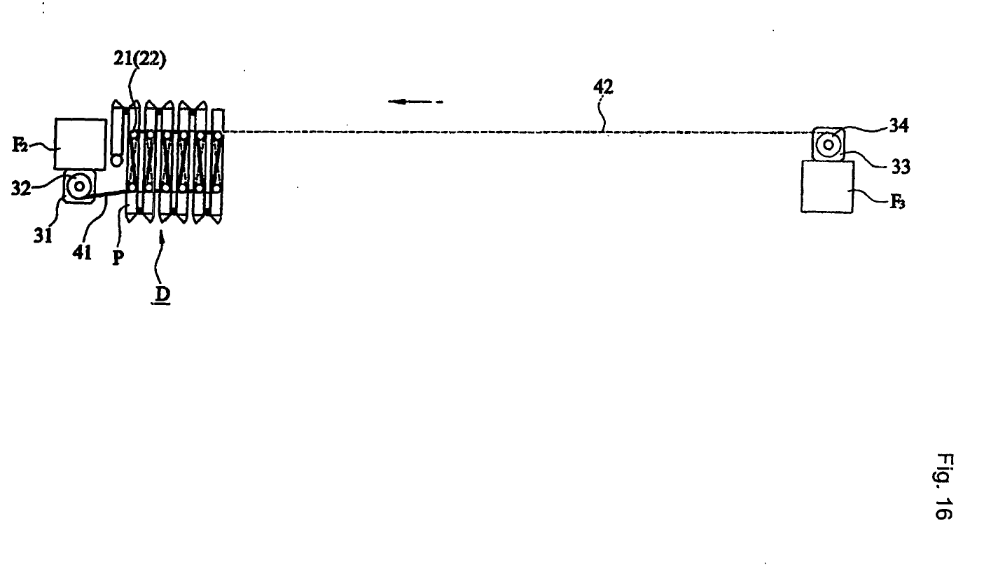

High tension is imposed on the winding wire 41, by which the tension roller 62 disposed near the folding motor 31 is pushed toward the opposite-tension direction, but the tension still can be maintained. The winding wire 41 is wounded on the reel 32 and draws each door leaf P. As shown in FIG. 16, each door leaf P moves toward the fixed end frame F2 and also rotates around the hinge means H, by which all door leaves P are folded against each other and the folding door D is open.

Since no power is applied to the spreading motor 33, the shaft of the spreading motor 33 can freely rotate. The releasing wire 42 is easily released from the reel 34 of the spreading motor 33 during the folding operation of the folding door D. The releasing wire 42 will not loosen beyond the limit since the predetermined tension is imposed to the releasing wire 42 by the tension roller 62 disposed near the spreading motor 33.

The winding wire 41 continuously runs on a pair of the first wire guider 21 in a zigzag manner such that the pulling force of the winding wire 41 is applied to each of the first wire guiders 21 disposed at the top portion of the door leaf P along a width direction in order to fold each door leaf P. Thus, the moment generated by the winding wire 41 is given to every door leaf simultaneously, which can open the folding door D with a small force.

In other word, the tension T is given to the winding wire 41 along the folding direction of the door leaf P as shown in FIG. 13. Because of the cross run of the winding wire 41 along the first wire guider 21, the counter-force is imposed to the winding wire 41 centered around the support pin 13, which has the same magnitude but in the opposite direction. Thus, the moment (M: M=T×L) is generated at each first wire guider 21 at the same time. In a conventional art, the folding door D must be folded such that the free end door leaf moves first and the next adjacent door leaf moves successively. However, in this invention, every door leaf is folded and moved simultaneously, by which the folding door D can be opened smoothly and easily with a little force.

Furthermore, since the wheels 17 provided at the lower end of each door leaf P run on along the rail 16, and each door leaf P can be manipulated operated by the motor 50 that synchronizes with the folding motor 31, which leads the easiest opening operation of the folding door.

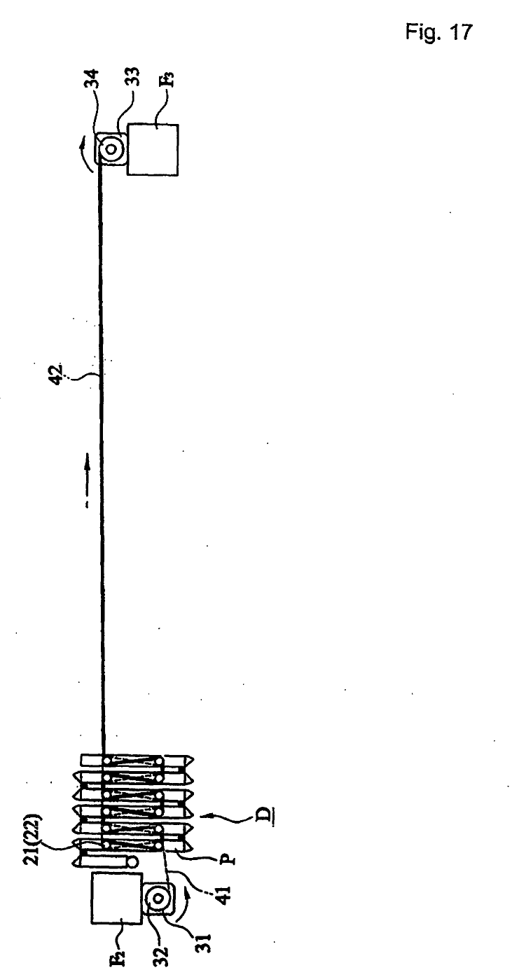

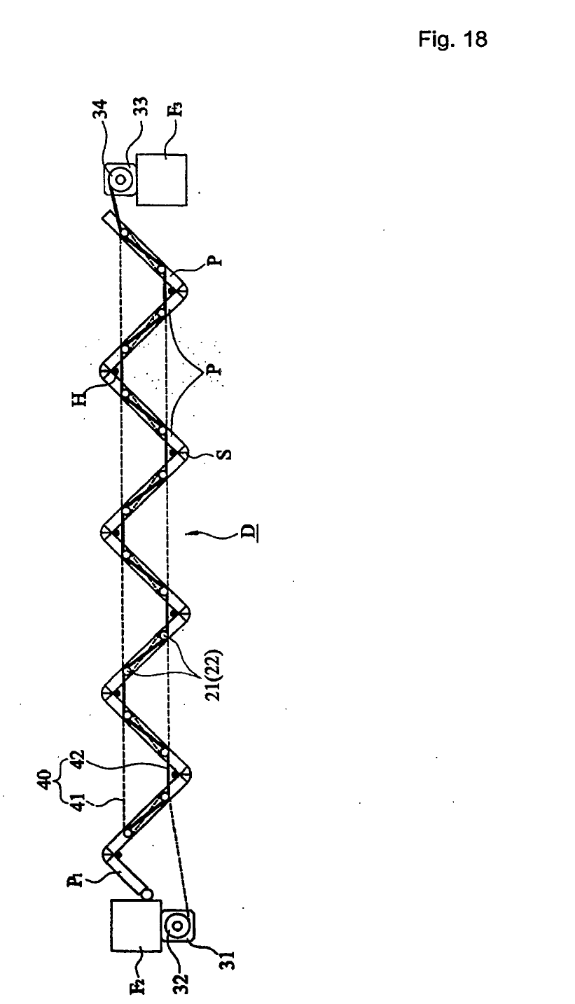

FIGS. 17 and 18 illustrate conceptually the operation of the close, in which the folded door D is spread to close the entrance of a structure. The operation is made in the reverse order as described at the above steps.

When the folding door D is open as shown in FIG. 17, as a close switch (not shown) turns on, power is given to the spreading motor 33. The shaft of the spreading motor 33 turns in a clockwise direction, and also turns the reel 34 provided on the shaft. High tension is imposed on the releasing wire 42, by which the tension roller 62 disposed near the spreading motor 33 is pushed toward the opposite-tension direction, but the tension still can be maintained.

As shown in FIG. 18, each door leaf P moves toward the free end frame F3 and also rotates around the hinge means H, by which all door leaves are spread away from each other and the folding door D is closed. Since no power is applied to the folding motor 31, the winding wire 41 is easily released from the reel 34 of the folding motor 31 during the spreading operation of the folding door D. The winding wire 41 will not loosen beyond the limit since the predetermined tension is imposed to the winding wire 41 by the tension roller 62 disposed near the folding motor 31.

The releasing wire 42 continuously runs on a pair of the second wire guider 22 in a zigzag manner such that the pulling force of the releasing wire 42 is applied to each of the second wire guider 22 disposed at the top portion of the door leaf P along a width direction in order to fold each door leaf P. Thus, the moment generated by the releasing wire 42 is given to every door leaf simultaneously, which can close the folding door D with a little force.

In other word, the tension T is given to the releasing wire 42 along the folding direction of the door leaf P as shown in FIG. 14. Because of the cross run of the releasing wire 42 along the second wire guider 22, the counter-force is imposed to the releasing wire 42 centered around the support pin 13, which has the same magnitude but opposite direction. Thus, the moment (M: M=T×L) is generated at each second wire guider 22 at the same time. Every door leaf is spread and moved simultaneously, by which the folding door D can be closed smoothly and easily with a little force.

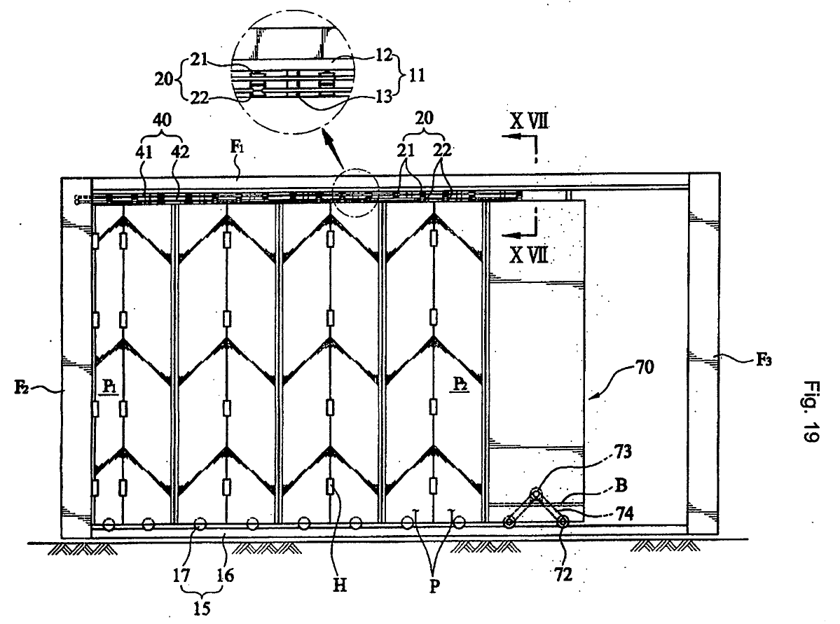

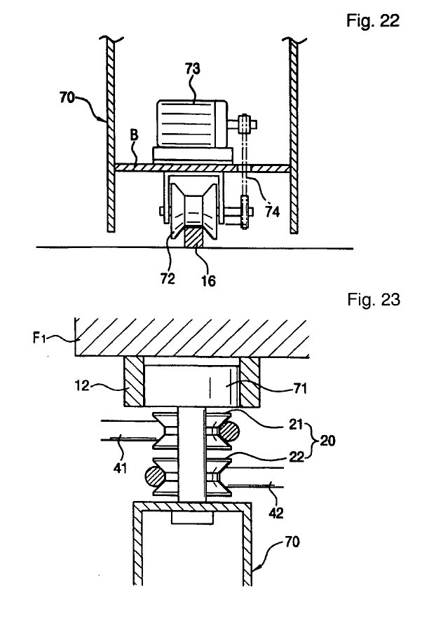

FIGS. 19 to 23 illustrate conceptually the second embodiment of the folding and spreading system according to the present invention. Only a few components of the second embodiment are different from the previously described embodiment, and two embodiments have an overall similar configuration. Therefore, the detailed description will be omitted for brevity's sake, denoting the same reference numerals of the same components described in the first embodiment.

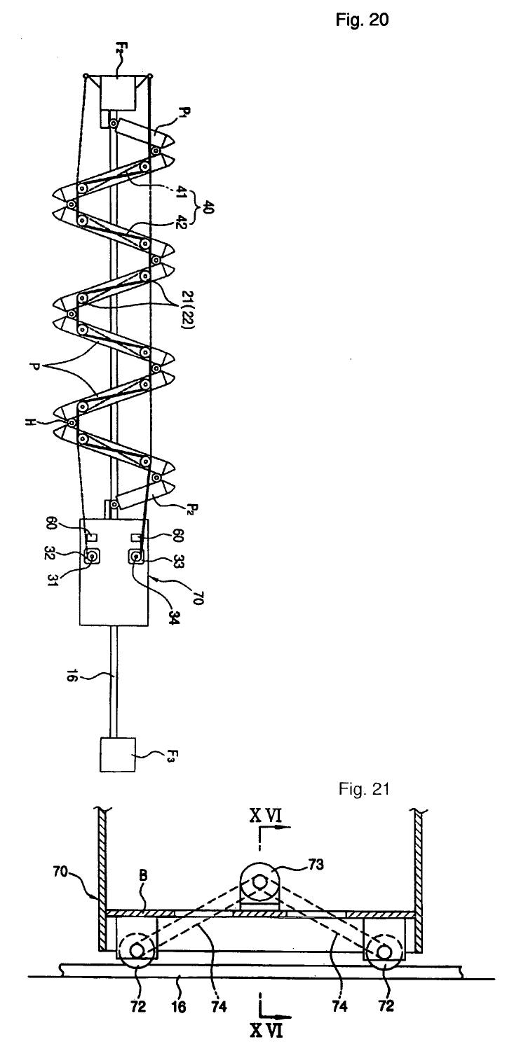

The second embodiment has supplemental components in addition to the components of the first embodiment as shown in FIGS. 19 and 20. A leading door 70 is hinge connected to the free end leaf P2 in order to give guidance to the close/open movement of the folding door D. Furthermore, on the leading door 70 is mounted the folding motor 31, the winding motor 32 and the tension maintainable means 60.

In this configuration, each individual end of the winding wire 41 and the releasing wire 42 is connected to the fixed end frame F2 of the folding door D, and each of the other individual ends is connected to the folding motor 31 and the spreading motor 33, respectively.

Since two motors 31, 33 mounted on the leading door 70 must accompany with the movement of the leading door 70 at the same time, the interference (tension offset) owing to the simultaneous run of two motors 31, 33 can take place. To avoid such interference, a different start time can be imposed to the two motors. In other word, the folding motor 31 runs earlier in a half wheel operation than the spreading motor 33.

The leading door 70 is configured as a box, and has a couple of guide rollers 71 provided at the top portion of the leading door 70 in a width direction, and wheels 72 provided at the bottom portion of the leading door 70 in a width direction. The guide rollers 71 run on along the guide channel 12 of the upper frame F1, and the wheels 72 run on along the rail 16. Each wheel 72 is connected to a motor 73 housed in the leading door 70 through a chain 74 in order to receive the rotation force from the motor 73.

The motor 73 can make a forward or a reverse rotation depending on the close or open signal transmitted from the outside source, and brings a synchronized operation with the folding motor 31 and the spreading motor 33.

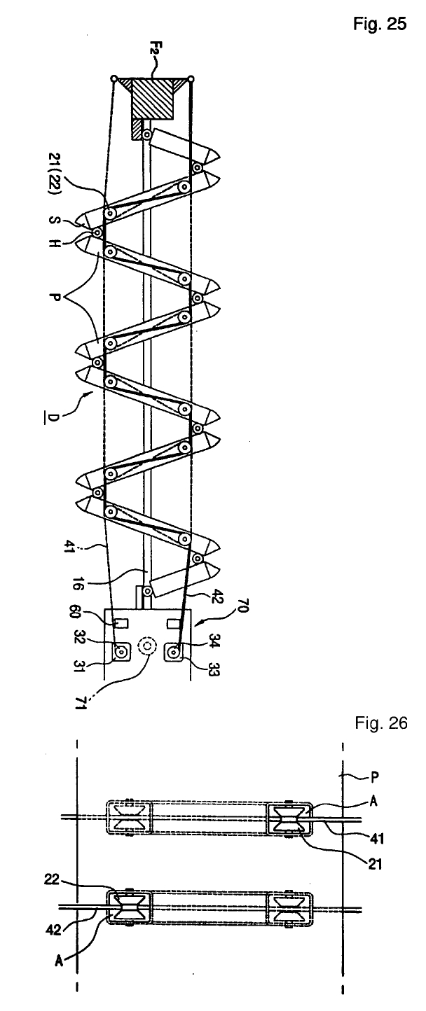

Firstly, as the open signal is received when the folding door D is closed as shown in FIG. 25, the motor 73 runs in a clockwise direction and the leading door 70 approaches toward the fixed end frame F2 of the folding door D. Simultaneously, the folding motor 31 runs in a clockwise direction and the reel 32 turns in the same direction, which pulls and winds the winding wire 41.

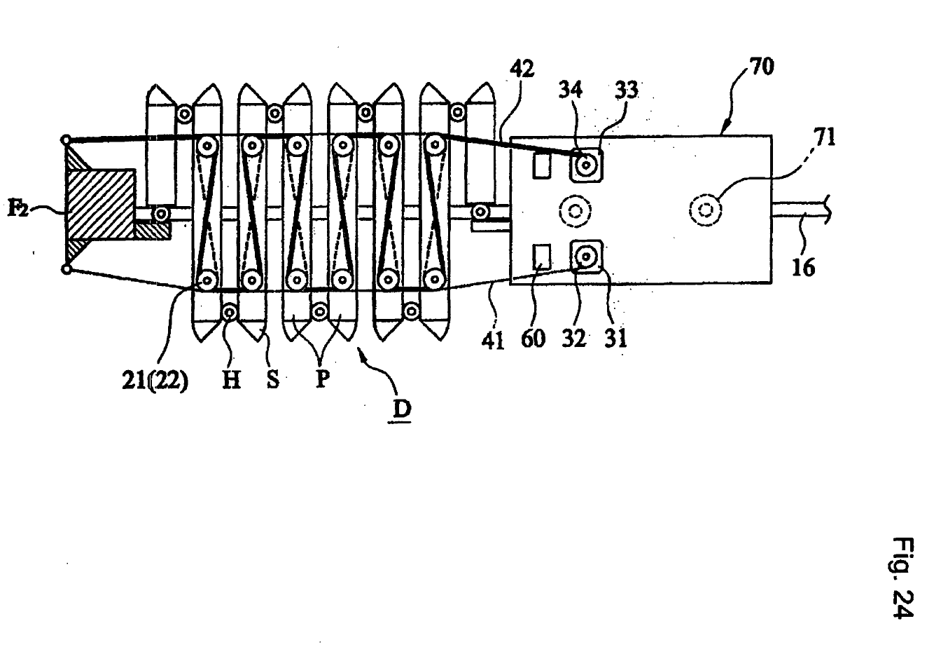

High tension is imposed on the winding wire 41, by which the tension roller 62 disposed near the folding motor 31 is pushed toward the opposite-tension direction. As shown in FIG. 24, moment is applied to a couple of the first wire guiders 21 in a folding direction of the door leaf P, by which all door leaves P are folded against each other and the folding door D is opened fast and easily.

The spreading motor 33 starts its operation in a clockwise direction after the elapsed time of the start of the folding motor 31 to wind the releasing motor 42. Since a little tension is given to the releasing wire 42 owing to the earlier start of the folding motor 31, the tension offset caused by the simultaneous run of two wires 41, 42 has not taken place.

In other words, the folding motor 31 runs in a clockwise direction earlier than the starting time of the spreading motor 33, and the high tension caused by the running of the folding motor 31 is imposed to the winding motor 41. On the other hand, the spreading motor 33 starts it's running after the running of the folding motor 31 in a predetermined interval later. The releasing wire 42 is loosened owing to the start time difference between the folding motor 31 and the spreading motor 33. Under the loose condition of the releasing wire 42, the spreading motor 33 runs to wind the releasing wire 42. That is why no high tension caused by the run of the spreading motor 33 is given to the releasing wire 42. Therefore, there is no offset tension between the winding wire 41 and the releasing wire 42 even if the motors 31, 33 run simultaneously.

At this time, the releasing wire 42 is pressed with a proper elasticity by the tension roller 62 disposed near the spreading motor 33, which maintains a little tension and brings no excessive suspension to the releasing wire, thus the releasing wire 42 is steadily wound on the reel 34.

In contrast, to close the folded door D, as a close switch (not shown) turns on, the motor 73 runs in a reverse direction and the leading door 70 moves towards the free end frame F3. Concurrently, the folding motor 31 runs in a reverse direction, and the reel 32 rotates in the same direction as the folding motor 31, thus releasing the winding wire 41. The winding wire 41 is loosened with keeping the basic tension generated by the tension roller 62.

Next, after the elapsed run time of the folding motor 31, the spreading motor 33 runs in a reverse direction, and the reel turns in the same direction as the spreading motor 33, thus releasing the releasing wire 42. The releasing wire 42 receives high tension generated by the run of the spreading motor 33, which maintains the stretched state.

That is, the releasing wire 42 runs on along the second wire guider 22 in a cross pattern in order to spread each door leaf P. The leading door 70 moves in a reverse direction for a while, and each door leaf is spread in a certain angle. At this time, the spreading motor 33 starts to give high tension to the releasing wire 42. Under high tension, the releasing wire 42 is released. The tension roller 62 disposed near the spreading motor 33 is pushed towards in an opposite-elasticity direction.

As shown in FIG. 24, moment is applied to a couple of the second wire guider 22 in a spreading direction of the door leaf P, by which all door leaves P are spread from each other and the folding door D is closed fast and easily.

In this case, also, the folding motor 31 starts earlier than the spreading motor 33, which brings the slack of the winding wire 41. Next, the spreading motor 33 turns to give high tension to the releasing wire 42, by which the tension offset caused by the simultaneous run of two wires 41, 42 has not taken place.

FIGS. 29 to 32 illustrate conceptually the third embodiment of the folding and spreading system according to the present invention. The third embodiment is the folding and spreading system in which a shutter is used as the folding door D. Some components of the third embodiment are different from the previous described embodiments. Therefore, the detailed description will be omitted for brevity's sake, denoting the same reference numerals of the same components described in the embodiments.

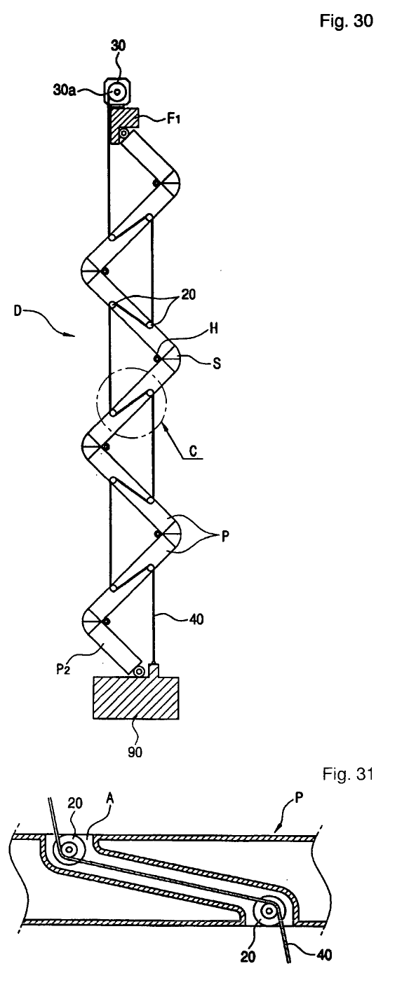

The folding and spreading system according to the third embodiment, as shown in FIGS. 29 and 30, comprises a guide means 80 for guiding an up and down movement of the folding door D, multiple pairs of the wire guiders 20 provided on each door leaf P in a width direction, the motor 30 mounted at the upper frame F1 for giving an up and down movement to the folding door D, and the wire 40 running successively through a path provided between each pair of wire guiders 20 and folding the adjacent door leaves P around the hinge means H by a run of the motor 30.

The guide means 80, as shown in FIG. 32, is comprised of a pair of guide channels 81 disposed at the fixed end frame F2 and the free end frame F3 facing to each other, and multiple guide rollers 82 protruded from a middle portion of each right and left end of each door leaf P and sliding along in the corresponding guide channel 81.

A pair of wire guiders 20 is preferably formed with a pulley, and only one pair is provided at each door leaf P. The wire guider 20 is disposed at a middle portion of the door leaf P, and is housed in the door leaf as shown in FIG. 31.

In the same way, a single motor 30 and a single wire 40 are adapted. The clockwise/counterclockwise motor constitutes the motor 30, and a reel 30a is provided at a rotation shaft of the motor 30 to wind the wire 40. The wire 40 runs on diagonally and successively through each wire guider 20 in order to fold two adjacent door leaves P around the hinge means H. One end of the wire 40 is connected to the free end or the bottom of the door leaf, and another end thereof is connected to the reel 30a of the motor 30.

The above configuration can perform the up and down movements of the folding door D. Desirably, an end block 90 is further provided at the free end frame P2 by the hinge means H, which acts as a weight. One end of the wire 40 is fixed to the end block 90. That means that the folding door D can easily be brought down owing to the end block 90 when in the close operation of the door D.

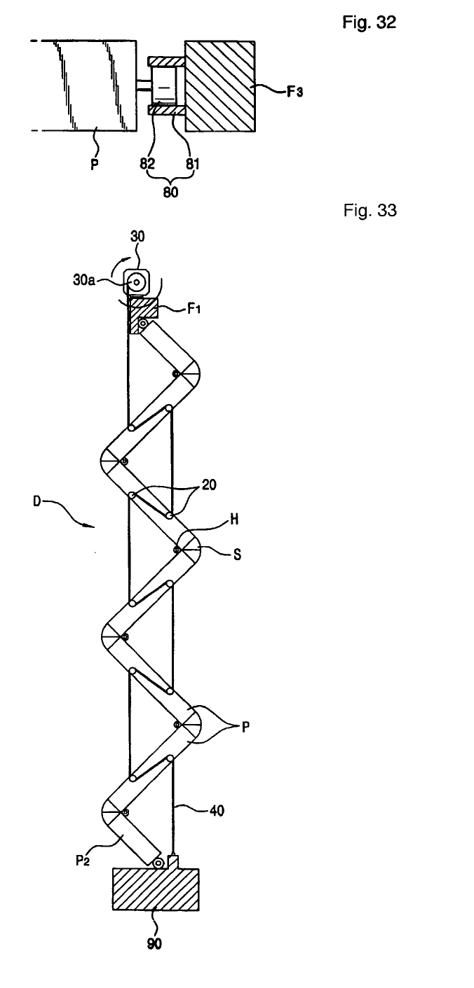

When the folding door D is closed as shown in FIG. 33, as an open switch (not shown) turns on, the motor 30 turns in a clockwise direction, and also turns the reel 30a. High tension is imposed on the wire 40. The wire 40 is wound on the reel 30a under a stretch condition.

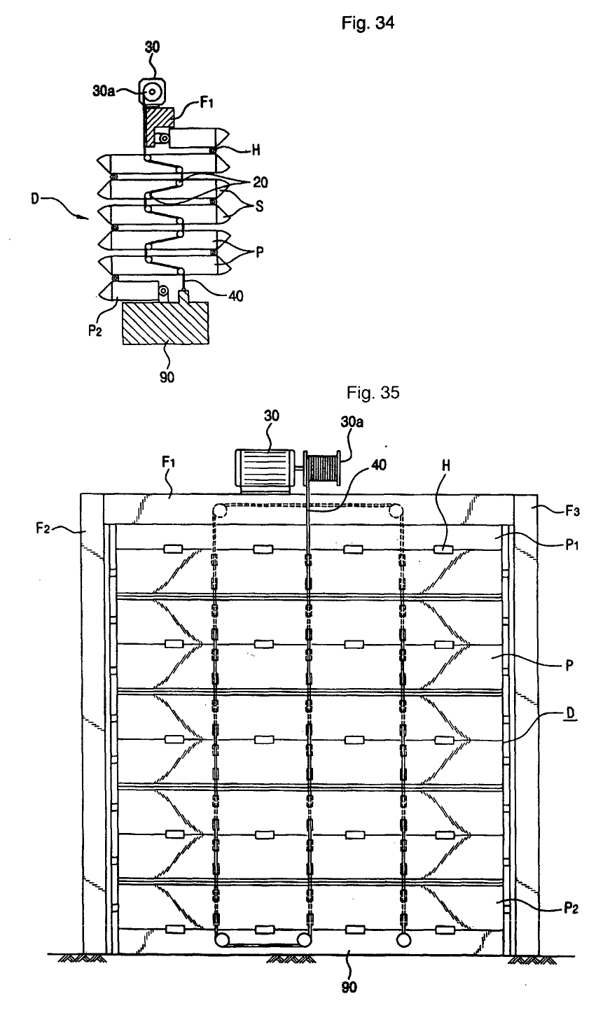

Each door leaf P is folded around the hinge means H, as shown in FIG. 34, and moved or rolled up toward the upper frame F1. The counter-force is imposed to two wire guiders 20 disposed on each end of door leaf P in a width direction, which has the same magnitude but the opposite direction. Thus, the moment is generated at each door leaf at the same time. The folding door D can be open smoothly and easily with a little force.

Under the open state of the folding door D, a close switch (not shown) turns on, and the motor 30 turns in a counterclockwise direction. The wire 40 wounded on the reel 30a is released with a constant speed. The end block 90 moves down with its weight. Each door leaf P is spread down at the same time as shown in FIG. 33, which closes the entrance.

Another configuration of the third embodiment is illustrated in FIG. 35. The structure employs additional wire guiders 20 in addition to the third embodiment. Each additional wire guider 20 is arranged on the folding door in multiple columns. The wire 40 runs on through the whole wire guiders 20, successively, which achieves the more stable close/open operation of the folding door.

### INDUSTRIAL APPLICABILITY

According to the folding and spreading system for half spread folding door described above, the moment generated by the pulling of the wire is simultaneously applied to each door leaf composing the folding door, by which the folding door can be closed/open easily and rapidly.

Furthermore, the easy operation can be achieved even by the very smaller capacity motors, and the smooth close/open operation can be attained.

1. A folding and spreading system for a half spread folding door using as an entrance of a large structure such as a depot or an air shed, each door leaf being successively connected with a hinge means, and the door having a zigzag form in its fully open state, the folding and spreading system comprising:
an upper and a lower guiding means for making the folding door move in a close or open direction;
a first wire guider provided at the depth portion of each door leaf in a predetermined distance from a neighboring first wire guider, and a second wire guider installed coaxially to the first wire guider;
a folding motor and a spreading motor provided at a free end frame and a fixed end frame of the folding door, respectively, and having a reel at each rotational shaft of each motor; and
a winding wire and a releasing wire extended diagonally through each of the first wire guider and the second wire guider of each door leaf, each end of the winding wire fixedly connected to the first wire guider of the free end leaf and to the winding reel of the folding motor, respectively, each end of the releasing wire fixedly connected to the second wire guider of the fixed end leaf and to the releasing reel of the spreading motor, respectively, in order to fold and spread the adjacent two door leaves around the hinge means.

2. The folding and spreading system for a half spread folding door according to claim 1, wherein:
the lower guider is comprised of a rail provided at the lower door frame and extended along a movement of the folding door, and multiple wheels provided rotationally at the lower end of the each door leaf and running on the rail.

3. The folding and spreading system for a half spread folding door according to claim 2, wherein:
the upper guider is comprised of a guide channel provided below the upper door frame and extended along a movement of the folding door, and multiple support pins uprightly extruded from the top end of each door leaf and slidingly inserted into the guide channel.

4. The folding and spreading system for a half spread folding door according to claim 3, wherein:
a motor running in the forward or reverse direction is further installed at the free end leaf of the folding door, the motor is connected to the wheel through a power delivery means, and the motor operates in synchronous with the folding motor and the spreading motor.

5. The folding and spreading system for a half spread folding door according to claim 4, wherein:
the motor is provided at an upper end of an upright shaft, and a wheel of the free end door leaf is provided at a lower end of the upright shaft, and the upright shaft is rotationally disposed at the free end door leaf.

6. The folding and spreading system for a half spread folding door according to claim 4, wherein:
a roller is rotationally coupled with the support pin and the roller slidingly moves in the guide channel.

7. The folding and spreading system for a half spread folding door according to claim 1, wherein:
a tension maintainable means is provided at a wire movement path, which pushes the winding wire and the releasing wire in order to maintain a proper tension of each wire.

8. The folding and spreading system for a half spread folding door according to claim 1, wherein:
a couple of wire guiders are installed at the top plan of each door leaf, or inside each door leaf.

9. The folding and spreading system for a half spread folding door according to claim 1, wherein:
a first wire guider is installed at the top plan of each door leaf, and a second wire guider is installed inside each door leaf.

10. The folding and spreading system for a half spread folding door according to claim 1, wherein:
a couple of wire guiders are comprised with a pulley rotationally provided at each door leaf.

11. A folding and spreading system for a half spread folding door using as an entrance of a large structure such as a depot or an air shed, each door leaf being successively connected with a hinge means, and the door having a zigzag form in its fully open state, the folding and spreading system comprising:
a guide channel for making the folding door move in a close or open direction;
an upper and a lower guiding means for making the folding door move in a horizontal direction;
multiple rollers protruded from a top plan of each door leaf and being slidingly run in the guide channel;
a rail provided at the lower door frame in a close or open direction of the folding door;
multiple wheels provided rotationally at the lower end of each door leaf and running on the rail;
a first wire guider provided at the depth portion of each door leaf in a predetermined distance from a neighboring first wire guider, and a second wire guider installed coaxially to the first wire guider;
a leading door connected with a hinge to the free end leaf, an upper end of the leading door being slidingly supported in the guide channel, and a lower end of the leading door having multiple wheels operated by a clockwise or counter-clockwise rotation motor, the wheels running along the guide channel;
a folding motor and a spreading motor provide at a free end frame and a fixed end frame of the folding door, respectively, and having a reel at each rotational shaft of each motor, and operating in synchronous with the rotation motor; and
a winding wire and a releasing wire extended diagonally through each of the first wire guider and the second wire guider of each door leaf, each end of the winding wire fixedly connected to the first wire guider of the free end leaf and to the winding reel of the folding motor, respectively, each end of the releasing wire fixedly connected to the second wire guider of the fixed end leaf and to the releasing reel of the spreading motor, respectively, in order to fold and spread the adjacent two door leaves around the hinge means.

12. The folding and spreading system for a half spread folding door according to claim 11, wherein:
the folding motor and the spreading motor are operated simultaneously, the folding motor runs earlier in a half wheel operation than the spreading motor.

13. The folding and spreading system for a half spread folding door according to claim 11, wherein:
a tension maintainable means is provided at a wire movement path, which pushes the winding wire and the releasing wire in order to maintain a proper tension of each wire.

14. The folding and spreading system for a half spread folding door according to claim 11, wherein:
a couple of wire guiders are installed at the top plan of each door leaf, or inside each door leaf.

15. The folding and spreading system for a half spread folding door according to claim 11, wherein:
a first wire guider is installed at the top plan of each door leaf, and a second wire guider is installed inside each door leaf.

16. The folding and spreading system for a half spread folding door according to claim 11, wherein:
a couple of wire guiders are comprised with a pulley rotationally provided at each door leaf.

17. A folding and spreading system for a half spread folding door using as an entrance of a large structure such as a depot or an air shed, each door leaf being successively connected with a hinge means, and the door having a zigzag form in its fully open state, the folding and spreading system comprising:
a guide channel disposed at a fixed end frame and a free end frame facing to each other;
a guide roller protruded from each right and left end of each door leaf and sliding along in the corresponding guide channel;
multiple wire guiders provided at the depth portion of each door leaf in a predetermined distance from a neighboring wire guider;
a clockwise or counterclockwise rotation motor provide at an upper door frame, and having a reel at a rotational shaft of the motor; and
a wire extended diagonally through the wire guiders, each end of the wire fixedly connected to the free end leaf and to the reel of the folding/spreading motor in order to fold and spread the adjacent two door leaves around the hinge means.

18. The folding and spreading system for a half spread folding door according to claim 17, wherein:
the wire guider is disposed at a middle portion of the door leaf, and is housed in the door leaf.

19. The folding and spreading system for a half spread folding door according to claim 17, wherein:
the wire guiders are arranged on the folding door in multiple columns, and the wire runs successively on the whole wire guiders in a form of a zigzag.

20. The folding and spreading system for a half spread folding door according to claim 17, wherein:
a couple of wire guiders are comprised with a pulley rotationally provided at each door leaf.

21. The folding and spreading system for a half spread folding door according to claim 11, wherein:
an end block acting as a weight is provided at the free end frame of the door.
